(19) United States
(12) Patent Application Publication
(10) Pub. No.: US 2023/0130282 A1
(43) Pub. Date: Apr. 27, 2023

(54) Fire Out Sprinkler Device

(71) Applicant: Angella Boglino, Sacramento, CA (US)

(72) Inventor: Angella Boglino, Sacramento, CA (US)

(21) Appl. No.: 18/048,481

(22) Filed: Oct. 21, 2022

Related U.S. Application Data
(60) Provisional application No. 63/270,146, filed on Oct. 21, 2021.

(51) Int. Cl. A62C 3/02; A62C 37/40; B05B 3/04

(52) U.S. Cl. CPC A62C 3/0292; A62C 37/40; B05B 3/0409

(57) ABSTRACT

The present invention relates to a novel sprinkler device. The device is designed to prevent the spread of wildfires to residential areas. The device comprises a plurality of sprinkler nozzle heads secured to a pole component. Each sprinkler nozzle head comprises a built-in sensor that will detect the presence of a fire, automatically activating the sprinkler nozzle head to extinguish a fire. Further, each sprinkler nozzle head comprises a backup system in case of a power failure, or the sensor fails. Further, the sprinkler heads can comprise a solar-powered battery and a manual power switch.

### CROSS-REFERENCE TO RELATED APPLICATION

The present application claims priority to, and the benefit of, U.S. Provisional Application No. 63/270,146, which was filed on Oct. 21, 2021, and is incorporated herein by reference in its entirety.

### FIELD OF THE INVENTION

The present invention relates generally to the field of sprinkler devices. More specifically, the present invention relates to an improved sprinkler device that provides residential areas with a comprehensive sprinkler system designed to prevent the spread of wildfires. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in sprinkler devices. Wildfires are incredibly dangerous and can spread quickly if not contained. Large, widespread fires may take weeks to combat, ultimately causing serious damage, injury, and death. Increasing numbers of annual wildfires in certain areas of the world are problematic, and users need quicker methods of dealing with these fires before they spread out of control.

The spread of wildfires to residential areas is a constant threat in many locations, particularly during dry seasons. Often such wildfires will cause damage to many homes and buildings which are burned either from direct contact with flames or from embers spewed from the fire that fall on the roofs of homes and buildings, sometimes from a long distance from the fire. Thus, such fires threaten destruction to large areas crowded with residential homes and other buildings. When a wildfire threatens a certain area, firefighters have little option but to directly fight the fire itself or take the necessary actions to address the threat of the fire spreading. A lack of manpower and adequate resources in many instances result in devastation of homes and buildings without any type of fire prevention or fire suppression equipment.

A variety of water systems for controlling wildfires that frequently approach a dwelling or a building have been employed in the past. Such systems disclose basic removable and manually operated sprinkler systems often supplied by garden hoses and meant to be placed on the roof when fires are approaching. Unfortunately, known removable roof top sprinkler systems are difficult to successfully place on the roof in order to reach all areas of the house and take considerable time to install on a roof when fires may be rapidly approaching. Thus, it is necessary for users to have a standalone sprinkler device for preventing the spread of wildfires to residential areas.

Therefore, there exists a long-felt need in the art for a sprinkler device that provides residential areas with a comprehensive sprinkler system designed to prevent the spread of wildfires. There is also a long-felt need in the art for a sprinkler device that features a standalone sprinkler with five nozzle heads that can rotate and offer wide area coverage for dispensing water. Further, there is a long-felt need in the art for a sprinkler device that includes built-in sensors within each sprinkler that can detect the presence of a fire and automatically activate the water nozzles. Moreover, there is a long-felt need in the art for a device that quickly activates the water system to help reduce the chance a wildfire spreading out of control and causing widespread structural and wildlife damage. Further, there is a long-felt need in the art for a sprinkler device that can be installed in numerous locations like residential neighborhoods, campsites, mountain range areas, etc. Finally, there is a long-felt need in the art for a sprinkler device that contains a back-up system in case of a power failure, or the sensor fails.

The subject matter disclosed and claimed herein, in one embodiment thereof, comprises a sprinkler device. The device is designed to prevent the spread of wildfires to residential areas. The device comprises a plurality of sprinkler nozzle heads secured to a pole component. Each sprinkler nozzle head comprises a built-in sensor that will detect the presence of a fire, automatically activating the sprinkler nozzle head to extinguish a fire. Further, each sprinkler nozzle head comprises a backup system in case of a power failure, or the sensor fails. Further, the sprinkler heads can comprise a solar-powered battery and a manual power switch. Typically, the one sprinkler nozzle head in the center is the largest and most powerful. It does not have to rotate but must sprinkle water in all directions up to 90 feet. Further, there are two rotating sprinkler nozzle heads at opposite corner ends of the pole component pointing upward and out. These will sprinkle water up to 60 feet. The other two sprinkler heads will be at the lower corner ends of the pole component and point downward. These should rotate and sprinkle water up to 30 feet.

In this manner, the sprinkler device of the present invention accomplishes all of the foregoing objectives and provides users with a device that prevents the spread of wildfires to residential areas. The device provides users with a standalone sprinkler with a plurality of sprinkler nozzle heads. The device can be installed in numerous locations, such as residential neighborhoods, campsites, mountain range areas, etc.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a sprinkler device. The device is designed to prevent the spread of wildfires to residential areas. The device comprises a plurality of rotating sprinkler nozzle heads secured to a standalone pole component.

In one embodiment, the standalone pole component is typically a cylindrical structure, but can be any suitable shape as is known in the art. Any pole-like structure can be utilized, as long as the structure can support the plurality of rotating sprinkler heads in a vertical position. Further, the standalone pole component can be any suitable shape and size as is known in the art, depending on the needs and/or wants of a user. Typically, the pole component is approximately of a length between 10-50 feet tall and would ideally be taller than the tallest tree in the area. Generally, the pole component would be manufactured of extruded aluminum, or any other suitable material as is known in the art.

In one embodiment, the pole component is a standalone pole component that comprises an anchoring base which can be permanently weighted with suitably heavy material. Typically, the anchoring base can be any suitable shape or structure as is known in the art. In another embodiment, the pole component is secured to the ground or other suitable surface, or secured to other sprinkler devices or secured to other suitable devices as is known in the art. In either embodiment, a plurality of sprinkler devices can be connected together in fluid communication to a central hub or other suitable central location and then tied to a common water source.

In one embodiment, the plurality of rotating sprinkler nozzle heads are secured within a sprinkler head assembly which is further secured to the standalone pole component. This allows the water sprayed from the nozzle heads to reach a large area so as no part of the residential area is left vulnerable to wildfires. Typically, the sprinkler head assembly would be secured to the pole component via a slip ring or pin connection, or any other suitable rotating means which allows the sprinkler head assembly to rotate. In another embodiment, each of the plurality of sprinkler nozzle heads is a rotating sprinkler and each of the nozzle heads is secured to the sprinkler head assembly via a slip ring or pin connection.

The plurality of sprinkler nozzle heads can be any typical nozzle head as is known in the art, depending on the needs and/or wants of a user, as well as how far a user wants the water to be expelled from the nozzle heads. If the sprinkler nozzle head is a rotating head, typically the sprinkler nozzle head would comprise an impellor or other suitable component as is known in the art to allow the nozzle head to rotate when water is pumped through. Additionally, the sprinkler nozzle heads further comprise a plurality of valves. The plurality of valves control water flow between the sprinkler nozzle heads, such that water may be directed only where needed. The sprinkler nozzle heads are typically manufactured from heat-sealable plastic or polymers, such as polypropylene or acrylonitrile-butadiene-styrene (ABS), or any other suitable material as is known in the art.

Further, any suitable number of nozzle heads can be utilized with the sprinkler head assembly as is known in the art, depending on the needs and/or wants of a user. In one embodiment, there are five sprinkler nozzle heads secured within the sprinkler head assembly. Typically, the one sprinkler nozzle head in the center is the largest and most powerful. It does not have to rotate but can rotate and would sprinkle water in all directions (360°) up to 90 feet. Further, there are also two rotating sprinkler nozzle heads at opposite corner ends of the sprinkler head assembly on the pole component, the two rotating sprinkler nozzle heads point upward and out. These will sprinkle water up to 60 feet. The other two sprinkler nozzle heads will be at the lower corner ends of the sprinkler head assembly on the pole component, the two rotating sprinkler nozzle heads point downward. These should rotate and sprinkle water up to 30 feet.

In one embodiment, the sprinkler head assembly comprises a water-inlet tube having at least one water-main connection at one end and the other end is then attached to a bottom of the sprinkler head assembly. Further, the plurality of rotating sprinkler nozzle heads each include a water conveyance connection in fluid communication with the water-inlet tube to aid in rotating the sprinkler nozzle heads.

Pressurized water is directed from a pressurized-water system, such as a community water-supply system or pulled from a water tower, and directed to the sprinkler head assembly via the water-main connection of the water-inlet tube. Optionally as a backup, the pressurized-water system includes a reservoir with water pressurization completed by a pump having a power system that is isolated from interruption by wildfires. The pump can be electrically powered with a motor and the power system can include a battery. Optionally, the pump can be heat-engine powered with a heat engine having engine fuel in the power system, or the pump can utilize a gas generator and/or can be a solar-powered pump.

In one embodiment, the device further includes a primary water shutoff valve in fluid communication with the sprinkler head assembly. Such a primary water shutoff valve is preferably adapted to receive and selectively transmit an external water supply to the sprinkler nozzle heads of the sprinkler head assembly via the water-inlet tube. The primary water shutoff valve automatically controls the amount of water transmitted to the sprinkler nozzle heads in order to cover the intended area with water so that the user is free to focus on other safety precautions.

In one embodiment, the device may further include a controller communicatively coupled to the primary water shutoff valve. Such a controller preferably generates and transmits a user input signal based upon a user input to remotely interrupt the external water supply prior to reaching the sprinkler nozzle heads. In this manner, water may be automatically directed into the device by electronic adjustment of the primary water shutoff valve requiring no manual activation by the user. Thus, the controller allows a user to either stay safely in the home or leave the site altogether and not worry about whether the house will be severely damaged, without the user constantly manually directing water to the approaching danger.

In one embodiment, each rotating sprinkler nozzle head and/or the sprinkler head assembly comprises a built-in sensor that will detect the presence of a fire, automatically activating the rotating sprinkler nozzle head to extinguish the fire. This solves the problem of manually activating a fire prevention system. Specifically, the built-in sensors may generate and transmit an information signal bearing a real-time temperature of the area associated therewith, as well as the location. The heat-detecting components of the built-in sensors allow the device to detect which part of the structure and/or area is in most danger and dispense water accordingly. Thus, the built-in sensors allow the device to focus the dispensing of water to the areas being at risk for fire damage to quickly prevent the threat. A user is thereby able to focus his/her attention on the safety of the occupants in the building and important personal items rather than trying to individually suppress an approaching wildfire.

Further, the device may also include a processor communicatively coupled to the built-in sensors and a memory electrically coupled to the processor. Such a memory preferably includes programmable software instructions that effectively cause water to selectively reach the sprinkler nozzle heads and extinguish the fire. Additionally, the memory may include programmable software instructions that include and execute a control logic algorithm.

The use of the controller in the present invention provides the benefit of enabling the user to preserve property and remain at a safe distance from oncoming fires rather than staying in a dangerous situation. Additionally, the combination of the memory and the processor within the device provides the benefit of enabling the user to set a maximum threshold temperature in order to prevent the device from activating when fire damage is not imminent.

In another embodiment, each rotating sprinkler nozzle head and/or the sprinkler head assembly comprises a backup system in case of a power failure, or in case the built-in sensor fails. In one embodiment, the backup system is a solar-powered battery which harnesses energy during the day. Further, if there is a power failure and/or if the solar-powered battery fails, the device comprises a manual override power switch. The manual override switch allows a user to manually turn on the sprinkler head assembly.

In yet another embodiment, the sprinkler device comprises a plurality of indicia.

In yet another embodiment, a method of preventing the spread of wildfires to residential areas is described. The method includes the steps of providing a plurality of rotating sprinkler nozzle heads secured to a standalone pole component. The method also comprises positioning the standalone pole component in a residential area. Further, the method comprises automatically activating the plurality of rotating sprinkler nozzle heads via a built-in sensor. Finally, sprinkling water in all directions up to 90 feet to extinguish a fire.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the sprinkler device of the present invention in accordance with the disclosed architecture;

FIG. 2 illustrates a perspective view of one embodiment of the sprinkler device of the present invention in operation in accordance with the disclosed architecture;

FIG. 3 illustrates a perspective view of one embodiment of the sprinkler device of the present invention wherein the sprinkler nozzles are rotating and spraying water in accordance with the disclosed architecture;

FIG. 4 illustrates a block diagram of the controller, processor, and memory in communication with the sprinkler device of the present invention in accordance with the disclosed architecture; and

FIG. 5 illustrates a flowchart showing the method of preventing the spread of wildfires to residential areas in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a sprinkler device that provides residential areas with a comprehensive sprinkler system designed to prevent the spread of wildfires. There is also a long-felt need in the art for a sprinkler device that features a standalone sprinkler with five nozzle heads that can rotate and offer wide area coverage for dispensing water. Further, there is a long-felt need in the art for a sprinkler device that includes built-in sensors within each sprinkler that can detect the presence of a fire and automatically activate the water nozzles. Moreover, there is a long-felt need in the art for a device that quickly activates the water system to help reduce the chance a wildfire spreads out of control and causes widespread structural and wildlife damage. Further, there is a long-felt need in the art for a sprinkler device that can be installed in numerous locations like residential neighborhoods, campsites, mountain range areas, etc. Finally, there is a long-felt need in the art for a sprinkler device that contains a back-up system in case of a power failure, or the sensor fails.

The present invention, in one exemplary embodiment, is a novel sprinkler device. The device comprises a plurality of sprinkler nozzle heads secured to a pole component. Each sprinkler nozzle head comprises a built-in sensor that will detect the presence of a fire, automatically activating the sprinkler nozzle head to extinguish a fire. Further, each sprinkler nozzle head comprises a backup system in case of a power failure, or the sensor fails. Further, the sprinkler heads can comprise a solar-powered battery and a manual power switch. The present invention also includes a novel method of preventing the spread of wildfires to residential areas. The method includes the steps of providing a plurality of rotating sprinkler nozzle heads secured to a standalone pole component. The method also comprises positioning the standalone pole component in a residential area. Further, the method comprises automatically activating the plurality of rotating sprinkler nozzle heads via a built-in sensor. Finally, sprinkling water in all directions up to 90 feet to extinguish a fire.

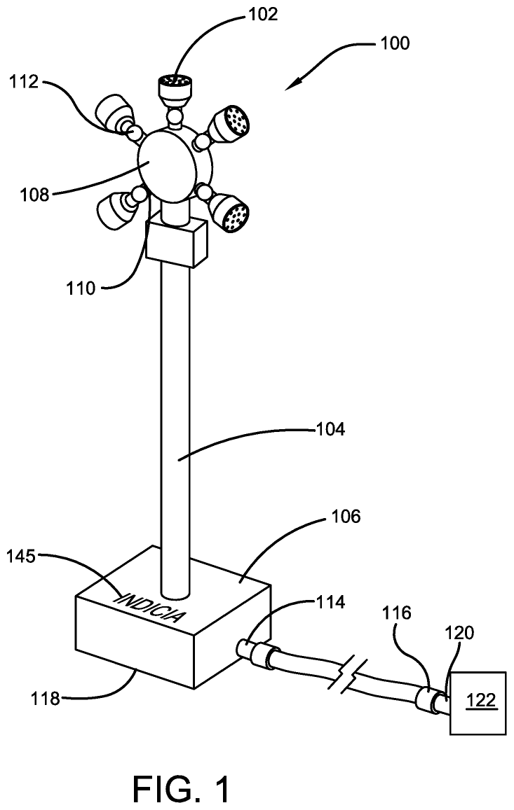

Referring initially to the drawings, FIGS. 1-3 illustrate a perspective view of one embodiment of the sprinkler device 100 of the present invention. In the present embodiment, the sprinkler device 100 is an improved sprinkler device that prevents the spread of wildfires to residential areas. The sprinkler device 100 further comprises a plurality of sprinkler nozzle heads 102 secured to a standalone pole component 104.

The standalone pole component 104 is typically a cylindrical structure, but can be any suitable shape as is known in the art. Any pole-like structure can be utilized, as long as the structure can support the plurality of rotating sprinkler nozzle heads 102 in a vertical position. Further, the standalone pole component 104 can be any suitable shape and size as is known in the art, depending on the needs and/or wants of a user. Typically, the pole component 104 is approximately of a length between 10-50 feet and would ideally be taller than the tallest tree in the area. Generally, the pole component 104 would be manufactured of extruded aluminum, or any other suitable material as is known in the art.

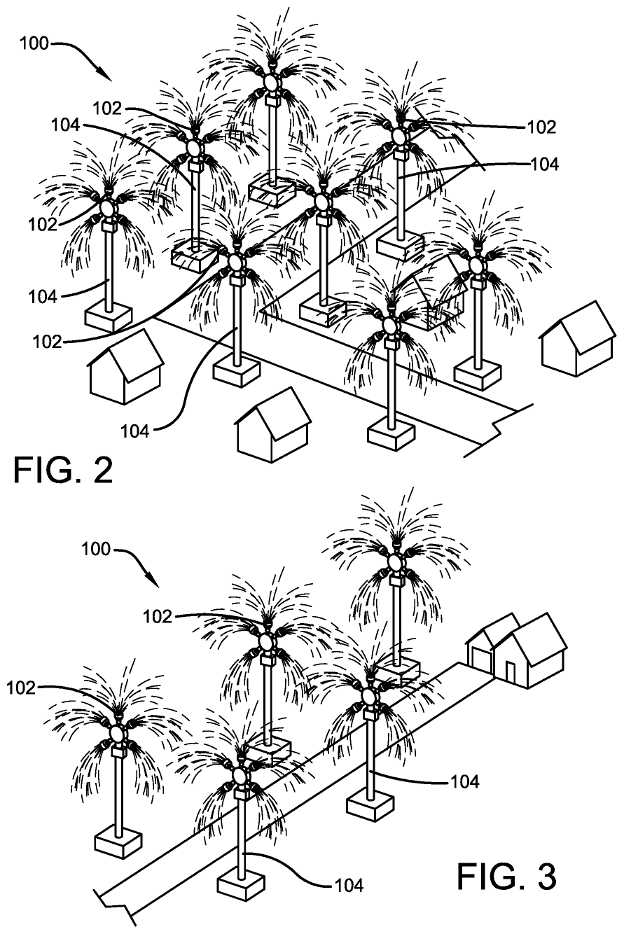

In one embodiment, the pole component 104 is a standalone pole component 104 that comprises an anchoring base 106 which can be permanently weighted with suitably heavy material. Typically, the anchoring base 106 can be any suitable shape or structure as is known in the art. In another embodiment, the pole component 104 is secured to the ground or other suitable surface, or secured to other sprinkler devices 100 or secured to other suitable devices as is known in the art. In either embodiment, a plurality of sprinkler devices 100 can be connected together in fluid communication to a central hub or other suitable central location and then tied to a common water source (as shown in FIGS. 2-3).

Furthermore, the plurality of rotating sprinkler nozzle heads 102 are secured within a sprinkler head assembly 108 which is further secured to the standalone pole component 104. This allows the water sprayed from the nozzle heads 102 to reach a large area, such that no part of the residential area is left vulnerable to wildfires. Typically, the sprinkler head assembly 108 would be secured to the pole component 104 via a slip ring or pin connection 110, or any other suitable rotating means which allows the sprinkler head assembly 108 to rotate. In another embodiment, each of the plurality of sprinkler nozzle heads 102 is a rotating sprinkler and each of the nozzle heads 102 is secured to the sprinkler head assembly 108 via a slip ring or pin connection 110.

The plurality of sprinkler nozzle heads 102 can be any typical nozzle head as is known in the art, depending on the needs and/or wants of a user, as well as how far a user wants the water to be expelled from the nozzle heads 102. If the sprinkler nozzle head 102 is a rotating head, typically the sprinkler nozzle head 102 would comprise an impellor or other suitable component as is known in the art to allow the nozzle head 102 to rotate when water is pumped through. Additionally, the sprinkler nozzle heads 102 further comprise a plurality of valves 112. The plurality of valves 112 control water flow between the sprinkler nozzle heads 102, such that water may be directed only where needed.

The sprinkler nozzle heads 102 are typically manufactured from heat-sealable plastic or polymers, such as polypropylene or acrylonitrile-butadiene-styrene (ABS), or any other suitable material as is known in the art, such as but not limited to, polyethylene, polyethylene terephthalate, polyvinyl chloride, polystyrene, polylactic acid, etc. Generally, the sprinkler device 100 is also manufactured from a material that is water resistant or waterproof, or the sprinkler nozzle heads 102 comprise a coating that is water resistant or waterproof.

Additionally, the sprinkler device 100 comprises a plurality of indicia 146. The sprinkler head assembly 108 of the sprinkler device 100 may include advertising, a trademark, or other letters, designs, or characters, printed, painted, stamped, or integrated into the sprinkler nozzle heads 102, or any other indicia 146 as is known in the art. Specifically, any suitable indicia 146 as is known in the art can be included, such as but not limited to, patterns, logos, emblems, images, symbols, designs, letters, words, characters, animals, advertisements, brands, etc., that may or may not be fire or sprinkler/brand related.

Further, any suitable number of nozzle heads 102 can be utilized with the sprinkler head assembly 108 as is known in the art, depending on the needs and/or wants of a user. In one embodiment, there are five sprinkler nozzle heads 102 secured within the sprinkler head assembly 108. Typically, the one sprinkler nozzle head 102 in the center is the largest and most powerful. It does not have to rotate but can rotate and would sprinkle water in all directions (360°) up to 90 feet. Further, there are also two rotating sprinkler nozzle heads 102 at opposite corner ends of the sprinkler head assembly 108 on the pole component 104, the two rotating sprinkler nozzle heads 102 point upward and out. These will sprinkle water up to 60 feet. The other two sprinkler nozzle heads 102 will be at the lower corner ends of the sprinkler head assembly 108 on the pole component 104, the two rotating sprinkler nozzle heads 102 point downward. These should rotate and sprinkle water up to 30 feet (as shown in FIGS. 2-3).

Furthermore, the sprinkler head assembly 108 comprises a water-inlet tube 114 having at least one water-main connection 116 at one end and the other end is then attached to a bottom 118 of the sprinkler head assembly 108. Further, the plurality of rotating sprinkler nozzle heads 102 each include a water conveyance connection 120 in fluid communication with the water-inlet tube 114 to aid in rotating the sprinkler nozzle heads 102.

Pressurized water is directed from a pressurized-water system such as a community water-supply system or pulled from a water tower and directed to the sprinkler head assembly 108 via the water-main connection 116 of the water-inlet tube 114. Optionally as a backup, the pressurized-water system includes a reservoir with water pressurization completed by a pump 122 having a power system that is isolated from interruption by wildfires. The pump 122 can be electrically powered with a motor and the power system can include a battery. Optionally, the pump 122 can be heat-engine powered with a heat engine having engine fuel in the power system, or the pump 122 can utilize a gas generator and/or can be a solar-powered pump.

Furthermore, the device 100 includes a primary water shutoff valve 124 in fluid communication with the sprinkler head assembly 108. Such a primary water shutoff valve 124 is preferably adapted to receive and selectively transmit an external water supply to the sprinkler nozzle heads 102 of the sprinkler head assembly 108 via the water-inlet tube 114. The primary water shutoff valve 124 automatically controls the amount of water transmitted to the sprinkler nozzle heads 102 in order to cover the intended area with water so that the user is free to focus on other safety precautions.

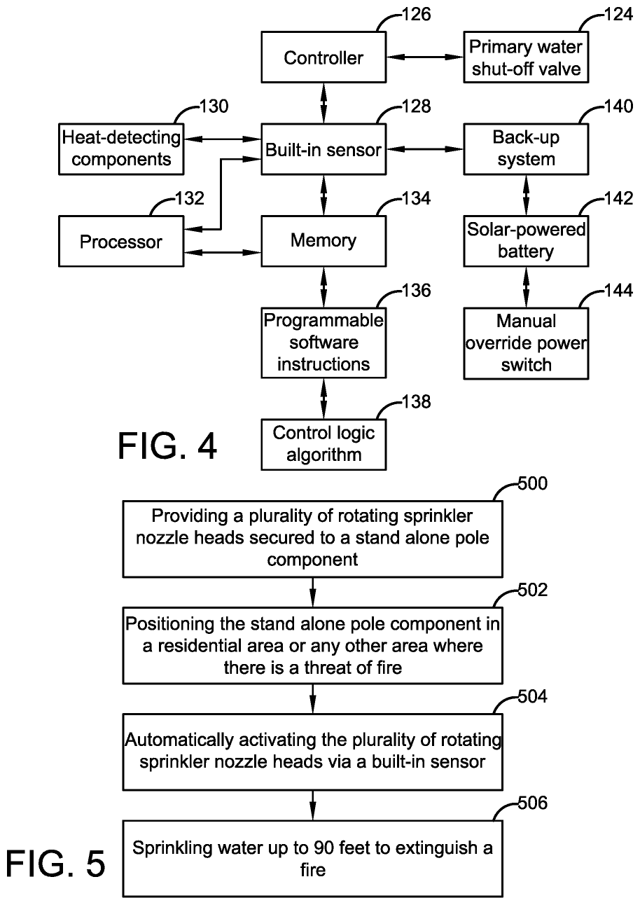

As shown in FIG. 4, the device 100 may further include a controller 126 communicatively coupled to the primary water shutoff valve 124. Such a controller 126 preferably generates and transmits a user input signal based upon a user input to remotely interrupt the external water supply prior to reaching the sprinkler nozzle heads 102. In this manner, water may be automatically directed into the device 100 by electronic adjustment of the primary water shutoff valve 124 requiring no manual activation by the user. Thus, the controller 126 allows a user to either stay safely in the home or leave the site altogether and not worry about whether the house will be severely damaged, without the user constantly manually directing water to the approaching danger.

Furthermore, each rotating sprinkler nozzle head 102 and/or the sprinkler head assembly 108 comprises a built-in sensor 128 that will detect the presence of a fire, automatically activating the rotating sprinkler nozzle head 102 to extinguish the fire. This solves the problem of manually activating a fire prevention system. Specifically, the built-in sensors 128 may generate and transmit an information signal bearing a real-time temperature of the area associated therewith, as well as the location. The heat-detecting components 130 of the built-in sensors 128 allow the device 100 to detect which part of the structure and/or area is in most danger and dispense water accordingly. Thus, the built-in sensors 128 allow the device 100 to focus the dispensing of water to the areas being at risk for fire damage to quickly prevent the threat. A user is thereby able to focus his/her attention on the safety of the occupants in the building and important personal items rather than trying to individually suppress an approaching wildfire.

Further, the device 100 may also include a processor 132 communicatively coupled to the built-in sensors 128 and a memory 134 electrically coupled to the processor 132. Such a memory 134 preferably includes programmable software instructions 136 that effectively cause water to selectively reach the sprinkler nozzle heads 102 and extinguish the fire. Additionally, the memory 134 may include programmable software instructions 136 that include and execute a control logic algorithm 138.

The use of the controller 126 in the present invention provides the benefit of enabling the user to preserve property and remain at a safe distance from oncoming fires rather than staying in a dangerous situation. Additionally, the combination of the memory 134 and the processor 132 within the device 100 provides the benefit of enabling the user to set a maximum threshold temperature in order to prevent the device 100 from activating when fire damage is not imminent.

Additionally, each rotating sprinkler nozzle head 102 and/or the sprinkler head assembly 108 comprises a backup system 140 in case of a power failure, or in case the built-in sensors 128 fails. In one embodiment, the backup system 140 is a solar-powered battery 142 which harnesses energy during the day. Further, if there is a power failure and/or if the solar-powered battery 142 fails, the device 100 comprises a manual override power switch 144. The manual override power switch 144 allows a user to manually turn on the sprinkler head assembly 108.

FIG. 5 illustrates a flowchart of the method of preventing the spread of wildfires to residential areas. The method includes the steps of at 500, providing a plurality of rotating sprinkler nozzle heads secured to a standalone pole component, wherein the plurality of rotating sprinkler nozzle heads are housed within a sprinkler head assembly. The method also comprises at 502, positioning the standalone pole component in a residential area or any other area where there is a threat of wildfires. Further, the method comprises at 504, automatically activating the plurality of rotating sprinkler nozzle heads via a built-in sensor. Additionally, engaging the back-up system if the built-in sensor fails. Finally, at 506, sprinkling water in all directions up to 90 feet to extinguish a fire, wherein the center sprinkler nozzle head sprinkles water in all directions, two rotating sprinkler nozzle heads point upward and out to sprinkler water, and another two rotating sprinkler nozzle heads point downward and out to sprinkle water.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “sprinkler device” and “device” are interchangeable and refer to the sprinkler device 100 of the present invention.

Notwithstanding the foregoing, the sprinkler device 100 of the present invention can be of any suitable size and configuration as is known in the art without affecting the overall concept of the invention, provided that it accomplishes the above-stated objectives. One of ordinary skill in the art will appreciate that the sprinkler device 100 as shown in FIGS. 1-5 are for illustrative purposes only, and that many other sizes and shapes of the sprinkler device 100 are well within the scope of the present disclosure. Although the dimensions of the sprinkler device 100 are important design parameters for user convenience, the sprinkler device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A sprinkler device that prevents the spread of wildfires to residential areas, the sprinkler device comprising:
a plurality of sprinkler nozzle heads; and
a pole component;
wherein the plurality of sprinkler nozzle heads are secured to the pole component in a vertical position;
wherein the plurality of nozzle heads rotate while spraying water; and
further wherein pressurized water is directed from a pressurized-water system and directed to the plurality of sprinkler nozzle heads.

2. The sprinkler device of claim 1, wherein the pole component is a standalone pole component.

3. The sprinkler device of claim 2, wherein the pole component comprises an anchoring base.

4. The sprinkler device of claim 3, wherein multiple sprinkler devices are connected together in fluid communication and tied to a common water source.

5. The sprinkler device of claim 1, wherein the plurality of sprinkler nozzle heads are secured within a sprinkler head assembly.

6. The sprinkler device of claim 5, wherein the sprinkler head assembly rotates and the plurality of sprinkler nozzle heads remain static.

7. The sprinkler device of claim 6, wherein the plurality of sprinkler nozzle heads comprise a plurality of valves which control water flow between the plurality of sprinkler nozzle heads.

8. The sprinkler device of claim 7, wherein the plurality of sprinkler nozzle heads comprise a plurality of indicia.

9. The sprinkler device of claim 8, wherein the sprinkler head assembly comprises a water-inlet tube connected to the pressurized-water system and to a water conveyance connection between the plurality of sprinkler nozzle heads.

10. The sprinkler device of claim 9 further comprising a primary water shutoff valve in fluid communication with the sprinkler head assembly.

11. The sprinkler device of claim 10 further comprising a controller in communication with the primary water shutoff valve.

12. The sprinkler device of claim 11, wherein each of the plurality of sprinkler nozzle heads comprise a built-in sensor that detects presence of a fire.

13. The sprinkler device of claim 12 further comprising a processor coupled to the built-in sensor and a memory coupled to the processor.

14. A sprinkler device that prevents the spread of wildfires to residential areas, the sprinkler head device comprising:
a plurality of rotating sprinkler nozzle heads secured to a standalone pole component in a vertical position;
a primary water shutoff valve in fluid communication with the plurality of rotating sprinkler nozzle heads; and
a controller in communication with the primary water shutoff valve;
wherein pressurized water is directed from a pressurized-water system and directed to the plurality of rotating sprinkler nozzle heads; and
further wherein the plurality of rotating sprinkler nozzle heads comprise a water-inlet tube connected to the pressurized-water system and to a water conveyance connection between the plurality of sprinkler nozzle heads.

15. The sprinkler device of claim 14 further comprising a backup system in case of a power failure.

16. The sprinkler device of claim 15, wherein the backup system comprises a solar-powered battery and a manual override power switch.

17. The sprinkler device of claim 14, wherein each of the plurality of rotating sprinkler nozzle heads comprise a built-in sensor that detects presence of a fire.

18. The sprinkler device of claim 17 further comprising a processor coupled to the built-in sensor and a memory coupled to the processor.

19. The sprinkler device of claim 14, wherein multiple sprinkler devices are connected together in fluid communication and tied to a common water source.

20. A method of preventing the spread of wildfires to residential areas, the method comprising the steps of:
providing a plurality of rotating sprinkler nozzle heads secured to a standalone pole component;
positioning the standalone pole component in a residential area or any other area where there is a threat of wildfires;
automatically activating the plurality of rotating sprinkler nozzle heads via a built-in sensor; and
sprinkling water in all directions up to 90 feet to extinguish a fire.
